(19) United States
(12) Patent Application Publication
(10) Pub. No.: US 2021/0108958 A1
(43) Pub. Date: Apr. 15, 2021

(54) METHOD AND REFRIGERATION APPARATUS FOR DETERMINING AN OBJECT WEIGHT OF AN OBJECT FOR REFRIGERATION

(71) Applicant: BSH Hausgeraete GmbH, Muenchen (DE)

(72) Inventors: Stephan Kempfle, Ellzee (DE); Joachim Schaeferling, Bissingen (DE); Gerhard Wetzl, Sontheim (DE)

(21) Appl. No.: 17/066,761

(22) Filed: Oct. 9, 2020

(30) Foreign Application Priority Data
Oct. 11, 2019 (DE) 102019215613

(51) Int. Cl. G01G 19/52; F25D 25/00; G01M 1/12; G01G 23/36

(52) U.S. Cl. CPC G01G 19/52; F25D 25/00; F25D 2700/06; G01G 23/36; G01M 1/122

(57) ABSTRACT

A method is used to determine an object weight of at least one object for refrigeration positioned on a weighing area with weighing plates of a household refrigeration appliance. The respective weights are measured in a time-resolved manner by means of the weighing plates and a sum of changes in weight determined within a predetermined period of time on the weighing plates is assigned to an object for refrigeration as its object weight. A refrigeration apparatus has a household refrigeration appliance with a refrigerating zone, which has a weighing area with a number of weighing plates. The refrigeration apparatus is configured to carry out the method.

### CROSS-REFERENCE TO RELATED APPLICATION

This application claims the priority, under 35 U.S.C. § 119, of German patent application DE 10 2019 215 613, filed Oct. 11, 2019; the prior application is herewith incorporated by reference in its entirety.

### BACKGROUND OF THE INVENTION

### Field of the Invention

The invention relates to a method for determining an object weight of at least one object for refrigeration positioned on a weighing area of a household refrigeration appliance. The invention also relates to a refrigeration apparatus, at least having a household refrigeration appliance with a refrigerating zone which has a weighing area, wherein the refrigeration apparatus is configured to carry out the method. The invention can be applied particularly advantageously to objects for refrigeration which are positioned in a door rack.

Japanese patent application JP 2013120048 A discloses a weight sensor arranged on a compartment support in a refrigerator having a set of four weight sensor, wherein a storage state of food in a storage container is determined by a strain gage sensor which is arranged between the storage container and a compartment support.

Japanese patent application JP 2007017052 A discloses a warehouse management device for articles stored in the refrigerator. The refrigerator contains a drawer with a weight sensor, a weight acquisition facility with a weight sensor, which acquires an object weight of articles, and a data processing facility which calculates a number of articles by the acquired object weight being divided by a weight per article and a data storage device which stores the number of stored articles.

Japanese patent application JP 2004323118 A discloses a weight measuring means which calculates a weight of food from a signal output by a weight sensor. The calculated weight is stored in a storage apparatus as a value of an initial weight of food. A resetting facility can be used to reset the weight value stored in the storage apparatus. The value of the initial weight is compared with a value of the current weight which is calculated by the weight measuring facility in order to calculate the residual quantity and to inform the user of the residual quantity by way of an information facility.

### BRIEF SUMMARY OF THE INVENTION

It is the object of the present invention to overcome the disadvantages of the prior art at least partially and to provide an option which is particularly easy to implement and user-friendly in order to automatically determine a weight of objects for refrigeration or articles positioned in a refrigerating zone of a household refrigeration appliance.

This object is achieved according to the features of independent claims. Advantageous embodiments form the subject matter of the dependent claims, the description and the drawings.

The object is achieved by a method for determining an object weight of at least one object for refrigeration positioned on a weighing area with several of a household refrigeration appliance, in which respective weights are measured in a time-resolved manner by means of the weighing plates and a sum of changes in weight determined on the weighing plates within a predetermined period of time is assigned to an object for refrigeration as its object weight.

This is advantageous in that a respective object weight can be easily and reliably determined also when a number of objects for refrigeration are positioned on a weighing area in practically any arrangement.

The predetermined period of time is advantageously selected so that the weights can be measured reliably by way of measuring technology and it is moreover so short that a positioning of different objects for refrigeration in temporal sequence on the weighing area can be differentiated in a manner typical to practice. It can lie e.g. between 0.1 s and 2 s, in particular between 0.5 s and 1 s. In one development a start of the period of time begins or is initiated with a measurement of a change in weight on at least one of the weighing plates.

The change in weight is in particular a noticeable change in weight above a predetermined weight threshold value, in order not to apply the method to objects for refrigeration already located in the door and moving by moving the door. The predetermined weight threshold value can lie for instance at ΔG=10 g or 20 g.

The change in weight can be an increase in weight or a reduction in weight. If in sum an increase in weight is established within the predetermined period of time, it is possible to conclude therefrom that an object for refrigeration is added to the weighing area. If, by contrast, a reduction in weight is in sum established within the predetermined period of time, this can indicate a removal of an object for refrigeration from the weighing area.

In one development the household refrigeration appliance has a refrigerator (e.g. a fridge-freezer) or a refrigerator. The household refrigeration appliance has in particular a coolable usable space (refrigerating zone), which can be closed by means of a door.

In one development the weighing plates are arranged in a grid, in particular arranged adjacent to one another practically directly or without a gap. This enables a particularly precise determination of an object weight. For instance, the grid can be a matrix pattern. The weighing plates can have at least approximately a rectangular weighing surface. For instance, the weighing area can consist of a (6×1), a (6×2), a (12×1) or a (12×2) grid of weighing plates. A weight placed on the weighing plates can be measured by means of each weighing plate. In one development, a weighing plate has a side length between 30 mm and 80 mm, e.g. for providing a weighing surface of approximately 40 mm×70 mm.

In one development, a database stores the object weight with which individual objects for refrigeration are positioned on the weighing area. As a result, storage can be improved for a user since he is not required to determine the weights separately. The objects for refrigeration can be identified by a user or automatically. The database can be a component of a storage system which can be queried by a user. For instance, the user can interrogate the objects for refrigeration located on the weighing area and associated weights by way of an application program (“app”) installed on a mobile user terminal such as a smartphone, tablet PC or similar. In one development, the storage enables an inventory list of available objects for refrigeration or the food in the refrigeration appliance linked to the objects for refrigeration to be maintained by a user for monitoring purposes, a presence of specific food linked to the objects for refrigeration to be monitored or listed for a specific recipe and/or if a predetermined minimum quantity of a specific food is not met, an automatic order to be output in order to create a message to a user or a virtual shopping list for a user etc.

In one embodiment a position of the object for refrigeration on the weighing plates is determined from the changes in weight determined within the predetermined period of time. This can be carried out advantageously easily and reliably. Here the position can comprise an identifier or determination of the weighing plates, in which an increase in weight has resulted within the predetermined period of time or on which the object for refrigeration is positioned.

In one development, the object weight of a weighed object for refrigeration positioned on the weighing area is stored in the database linked together with its position. As a result, storage can be improved for a user, since he can automatically also be informed of the position of the at least one object for refrigeration.

In one embodiment, a center of gravity of the object for refrigeration is determined on the basis of the changes in weight, in particular increases in weight, determined on the weighing plates. A particularly simple measure of determining the position can advantageously be provided. The center of gravity of the object for refrigeration can be calculated for instance as a geometric center point of any (known) center points of the weighing plates, on which an increase in weight has been established, advantageously weighed with the weights measured on these weighing plates.

In one embodiment, at least one camera is used to record at least one image of the weighing area. The type and position of objects for refrigeration located on the weighing area is determined from the at least one image. An agreement of positions determined by means of the weighing plates and positions of objects for refrigeration determined from the at least one image is checked, and with an agreement of the positions for a respective object for refrigeration, its type is linked to the object weight thereof.

The advantage is achieved in that the weighted object for refrigeration can additionally automatically be reliably identified in respect of its type or content. The determination of the type and position of objects for refrigeration located on the weighing area from the at least one image can be carried out by means of an image evaluation or identified as an image evaluation.

The type of weighted object for refrigeration can comprise a type of a content of the object for refrigeration and/or a type of packaging. For instance, the content of the object for refrigeration can comprise a recognition of milk, juice, butter etc. The type of packaging can comprise recognizing or determining a 1-liter Tetra Pak packaging, a gallon or half-gallon bottle, etc. Depending on the accuracy of the object for refrigeration recognition and/or the extent of stored reference data, the type of object for refrigeration can be determined more accurately, for instance the type of milk (whole milk, skimmed milk etc.), the type of juice (orange juice etc.), a sell-by date etc. For this purpose optical character recognition (OCR) can also be carried out with the scope of the object for refrigeration recognition. If a user places an object for refrigeration on the weighing area, the entries “1 liter carton of whole milk” and “400 g” can be saved in the database, for instance.

In one development, the object weight determined for an object for refrigeration is stored with its type linked in the database. As a result, clarity of the storage can be further improved for a user, since he can automatically also be shown the type of the at least one object for refrigeration. Conveniently the user also does not need to enter the type of object for refrigeration itself as an entry into the database (but can if desired e.g. for correction or detailing purposes).

In one development, the type of weighted object for refrigeration is entered by a user and stored in the database. This is advantageous for instance if the object for refrigeration is not identified by the object for refrigeration identification or not identified with sufficient detail for a user. A user can therefore assign the type of “carrot-celery juice” to a specific weighted object for refrigeration by way of the app, for instance.

The fact that at least one image of the weighing area is recorded means that objects for refrigeration positioned on the weighing area can therefore also be recorded. The at least one image is advantageously recorded with a viewing direction obliquely from above onto the weighing area, in order to be able to fully acquire the weighing area and to be able to carry out a reliable recognition of the support surfaces of the objects for refrigeration.

In one development, a type and position only for objects for refrigeration located on the weighing area is determined from the at least one image, the support surface of which comprises weighing areas for which a change in weight has previously been established. A computing effort can advantageously be reduced for the object determination.

In one development, the at least one image is recorded by at least one camera installed fixedly in the refrigeration appliance (known as CiF or Camera-in-Fridge). For a particularly reliable determination of the support surfaces, it is advantageous that images of the weighing area are recorded and evaluated by a number of cameras from different angles of view. The at least one camera can be arranged e.g. in the carcass (there for instance in its ceiling) and/or in a door of a refrigerating zone. A number and position of the objects for refrigeration positioned on the weighing area can also be determined particularly easily and accurately by means of the camera.

In one embodiment, a position of a support surface of the object for refrigeration can be determined in respect of the weighing plates in order to determine the position of at least one object for refrigeration. This is advantageous in that a correlation between an object for refrigeration and the weights measured for this purpose can be established particularly easily and reliably. In particular, support surfaces of the objects for refrigeration can be determined proportionately by percentage on the weighing plates. It can be recognized for instance that about 20% of a support surface of a specific object for refrigeration is located on a first weighing plate, about 50% on a second weighing plate adjacent thereto and about 30% on a third weighing plate adjacent to the second weighing plate, etc.

In one embodiment the grid of the weighing plates overlies the image in order to determine the position of at least one object for refrigeration. This is advantageous in that an assignment of image regions of the image to the weighing plates can be performed particularly easily and the correlation of the support surfaces of the objects for refrigeration to the individual weighing plates can therefore also be determined particularly easily. Such a superimposition can be understood to mean that it is known which image regions or image points of an image are assigned to the individual weighing plates. This can include the grid dimension or the local division of the weighing plates of the weighing area being stored in an image or the camera, by taking into account the geometric arrangement between the camera and the weighing area.

In one embodiment, a liquid volume is determined from the determined object weight of at least one weighted object for refrigeration and its recognized type as liquid container. The liquid volume can be stored in the database linked to this object for refrigeration. This produces the advantage that, for liquids, the information provided to a user is not the weight but—usually more familiar to a user—the liquid volume, e.g. 0.5 l. This also facilitates the creation of an electronic shopping list or the comparison with a recipe. This conversion benefits from the fact that the weight of liquid food frequently corresponds with sufficient accuracy to the weight of water, so that the volume of the assigned object for refrigeration can be concluded from its determined weight. However, with a known or stored relationship between the weight of the liquid and its volume, the liquid volume can be determined more accurately. This is particularly useful if the specific weight of the liquid noticeably moves away from the specific weight of the water e.g. soups.

If the type of packaging is also determinable by object recognition and if the weight of the packaging is known, then the liquid volume can be determined even more precisely by subtracting the weight of the packaging from the measured object weight.

In a development, by comparing the determined liquid volume with a stored volume of packaging of the object, a filling level is determined, for example as a percentage or in categorized divisions such as “full”, “almost full”, “half full”, “almost empty”, etc., wherein in the case of categorized divisions ranges of the liquid volume that fit the categories are stored.

The object is also achieved by a refrigeration apparatus, at least having a household refrigeration appliance with a refrigerating zone, which has a weighing area with a number of weighing plates, wherein the refrigeration apparatus is designed to carry out the method as described above. The refrigeration apparatus can be embodied similarly to the method and has the same advantages. In one development the household refrigeration appliance can have at least one camera.

In one embodiment, the weighing area is located in a door rack of a door of the household refrigeration appliance. In particular, the base of the door rack is formed or configured practically entirely by means of the weighing area. As an alternative or in addition, at least one weighing area can be located on a tray in the refrigerating zone of the refrigerator, for instance on a storage compartment.

In one embodiment, the door rack or at least its side edge, consists of a transparent material, which facilitates an object for refrigeration acquisition by means of the camera, in particular improves a visibility of the support surface of the objects for refrigeration on the weighing area with an oblique arrangement of the camera with respect to the weighing area.

In one embodiment, the household refrigeration appliance corresponds to the refrigeration apparatus and has a data processing apparatus for carrying out the method. An autonomous or largely autonomous automated storage can advantageously be provided by the household refrigeration appliance. The data processing apparatus can be a standalone component of the refrigeration appliance, functionally integrated in a controller of the weighing area and/or integrated in a control facility of the refrigeration appliance.

In one embodiment, the household refrigeration appliance has a communication apparatus for data exchange with an external instance and is designed to send the measured weights and the at least one image to the external instance, and the external instance is designed to determine the object weights of at least one respective object for refrigeration therefrom. As a result, the effort involved in carrying out the method can be transferred from the household refrigeration appliance to the external unit, as a result of which the household refrigeration appliance can be implemented particularly easily and cost-effectively. The refrigeration apparatus according to this embodiment can then also be considered or identified as a system with a household refrigeration appliance and an external instance coupled thereto via data communications. The external instance can be a network server, a network-based computer (Cloud computer) and/or a mobile network terminal, for instance. The communication apparatus can be a wireless communication apparatus such as a Wi-Fi module, Bluetooth module etc. and/or a wired communication apparatus such as an Ethernet module etc.

Other features which are considered as characteristic for the invention are set forth in the appended claims.

Although the invention is illustrated and described herein as embodied in a method and refrigeration apparatus for determining an object weight of an object for refrigeration, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, perspective view of a refrigerator with an opened refrigerator door, which has a number of door racks internally;

FIG. 2 is a top, perspective view of a door rack with a weighing area;

FIG. 3 is a top plan view of the door rack from FIG. 2 with objects for refrigeration positioned thereupon; and

FIG. 4 is a flow chart for carrying out the method.

### DETAILED DESCRIPTION OF THE INVENTION

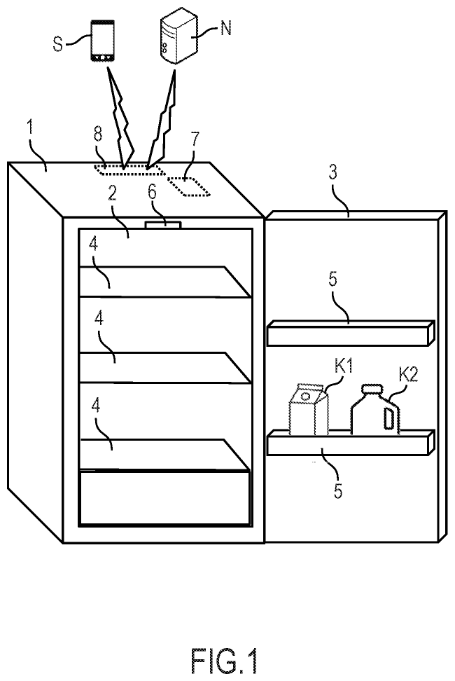

Referring now to the figures of the drawings in detail and first, particularly to FIG. 1 thereof, there is shown a refrigerator 1 with a refrigerating zone 2, which can be closed by means of a refrigerator door 3 shown open here. Objects for refrigeration K1, K2 can be stored on storage compartments 4 of the refrigerating zone 2 and in door racks 5. The door racks 5 are arranged on an interior of the refrigerator door 3. The refrigerator 1 also has a camera 6 integrated fixedly in a ceiling of the refrigerating zone 2, by means of which images of at least one of the door racks 5 can be recorded, for instance if the refrigerator door 3 is located in a predetermined angular position during a closing process. Here the images also comprise the objects for refrigeration K1, and K2 stored in the door racks 5.

The refrigerator 1 moreover has a central control facility 7, which is coupled to the camera 6, and is designed for image evaluation of images recorded by means of the camera 6.

The refrigerator 1 optionally has at least one communication module 8 (e.g. a Bluetooth module, a Wi-Fi module and/or an Ethernet module) for communication with at least one external instance, e.g. a network server N, a Cloud computer (not shown) and/or a mobile user terminal S.

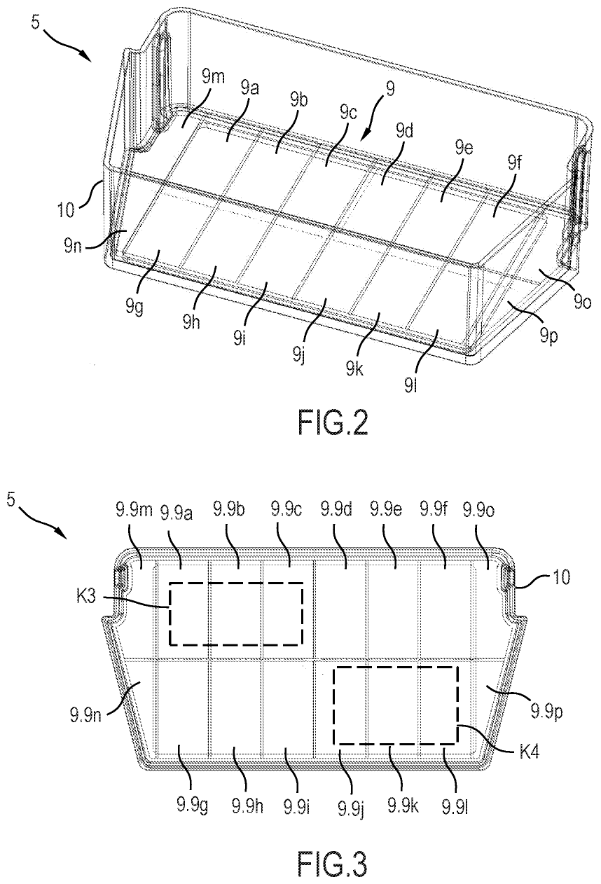

FIG. 2 shows in a view obliquely from above the door rack 5 with a weighing area 9, which rests on a base of the door rack 5 or forms the base. The door rack 5 as such (without the weighing area 9) has optically transparent side walls 10 and advantageously consists entirely of an optically transparent material e.g. plastic.

The weighing area 9 has twelve rectangular weighing plates 9a to 9l arranged adjacent to one another practically without a gap in a matrix-shaped (6×2) grid. Furthermore, the weighing area 9 can have further weighing plates 9m to 9p for edge-side filling of the base of the door rack 5, in which case a matrix-shaped (8×2) grid is then present. The further weighing plates 9m to 9p have another shape and/or size than the weighing plates 9a to 9l. The weighing area 9 has a controller (not shown), which records the analog measuring data generated by the weighing plates 9a to 9p and converts the same into corresponding weight data.

Object weights of respective objects for refrigeration can be determined by means of the control facility 7 from changes in weight measured on the weighing plates 9a to 9p within a predetermined period of time and stored in a database internal or external to the device (e.g. integrated in the external instance S, N) together with the weighing plates 9a to 9p actuated in this way.

An object for refrigeration recognition with respect to the objects for refrigeration positioned and weighed on the weighing area 9 is also carried out in an image of the camera 6 by means of the control facility 7, and its type and also the weighing plates 9a to 9p, on which the objects for refrigeration are positioned in each case, is recognized.

FIG. 3 shows the door rack 5 in the top view. Objects for refrigeration K3 and K4 positioned thereupon are indicated with dashed lines. The object for refrigeration K3 rests on the weighing plates 9a to 9c while the object for refrigeration K4 rests on the weighing plates 9j to 9l.

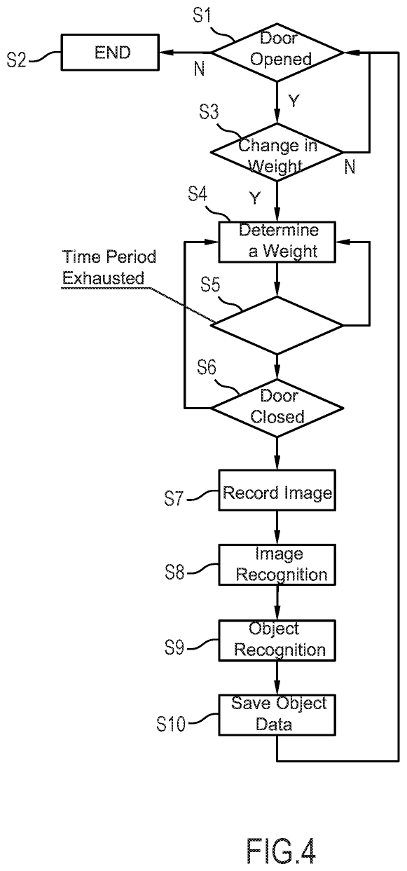

FIG. 4 shows a possible flow chart for carrying out the method, which is explained in more detail by way of example on the basis of the refrigerator 1 and FIG. 3. It is assumed that the object for refrigeration K4 was already placed on the weighing area 9 at the start of the method.

In a step S1, a check is carried out to determine whether the refrigerator door 3 is opened or has been opened. If no (N), the method is ended in step S2. In one variant, the method can then only be started if the refrigerator 3 is opened.

If yes (“Y”), a check is carried out in step S3 to determine whether a noticeable change in weight ΔG occurs on at least one of the weighing plates 9a to 9p. If no (“N”), the method goes back to step S1.

If yes (“Y”), in step S4 weights G measured on the weighing plates 9a to 9p are acquired and therefrom the respective change in weight ΔG is determined in respect of a time instant immediately before the change in weight. Such a change in weight ΔG is currently determined by setting the object for refrigeration K3 in the door rack 5, namely only an increase in weight ΔG>0 on the weighing plates 9a, 9b and 9c, e.g. according to ΔG(9a)=+200 g, ΔG(9b)=+700 g and ΔG(9c)=+100 g, based on a previously missing weight support. In the present case, the increases in weight ΔG therefore correspond to the correspondingly measured weights G, in other words ΔG(9a)=G(9a), etc.

The object weight O (K3) of the object for refrigeration K3 can be concluded according to:

O(K3)=G(9a)+G(9b)+G(9c)=200 g+700 g+100 g=1000 g.

Moreover, its position on the weighing plates 9a, 9b and 9c is known.

In a step S5, a check is carried out to determine whether the predetermined period of time has been reached or exceeded since the occurrence of the noticeable change in weight in step S3. If no (“N”), the method goes back to step S4.

If yes (“Y”), a check is carried out in step S6 to determine whether the refrigerator door 3 is closed and in the process has reached a predetermined door opening angle. If no (“N”), the method goes back to step S4.

If yes (“Y”), in step S7, at least one image of the weighing area 9 is recorded by means of the at least one camera 6, in the present exemplary embodiment including the objects for refrigeration K3 and K4 located therein.

In a step S8, the support surfaces and thus the positions and, if possible, the type of objects for refrigeration K3 and K4 identified in the image are then identified in step S8 by image recognition. In particular, it is possible to identify upon which weighing plates 9a to 9p the objects for refrigeration K3, K4 rest.

In a step S9, a check is carried out to determine whether an object for refrigeration K3, K4 recognized by image recognition rests on the weighing plates 9a to 9c actuated in step S3 and/or step 4. This is currently the case for the object for refrigeration K3, so that the object weight determined by means of the weighing plates 9a to 9c is assigned to the object for refrigeration K3 identified in step S8 on the same weighing plates 9a to 9c.

In a step S10, the type of object for refrigeration K3, its object weight O (K3) and possibly its position (for instance the weighing plates 9a to 9c, on which the object for refrigeration K3 rests), are saved in a database for the purpose of storage.

A move back to step 1 is then made.

The present invention is naturally not restricted to the exemplary embodiment shown.

The position of the object for refrigeration K3 and also its center of gravity of the object for refrigeration can therefore be determined and compared with a center of gravity of the object for refrigeration determined by image evaluation.

In general, “a”, “an”, etc. can be understood as singular or plural, in particular in the sense of “at least one” or “one or more”, etc., provided this is not explicitly excluded, e.g. by the expression “exactly one”, etc.

A numerical value can also include the given value as a typical tolerance range, provided this is not explicitly excluded.

The following is a summary list of reference numerals and the corresponding structure used in the above description of the invention:
1 refrigerator
2 refrigerating zone
3 refrigerator door
4 storage compartments
5 door rack
6 camera
7 control facility
8 communication module
9 weighing area
9a-9p weighing plate
10 side wall of the door rack
K1-K4 object for refrigeration
N network server
S mobile user terminal

1. A method for determining an object weight of at least one object for refrigeration positioned on a weighing area with a plurality of weighing plates of a household refrigeration appliance, which comprises the steps of:
measuring respective weights in a time-resolved manner by means of the weighing plates and a sum of changes in weight determined on the weighing plates within a predetermined period of time is assigned to the at least one object for refrigeration as the object weight.

2. The method according to claim 1, which further comprises determining a position of the at least one object for refrigeration on the weighing plates from the changes in weight determined within the predetermined period of time.

3. The method according to claim 2, which further comprises determining a center of gravity of the at least one object for refrigeration on a basis of the changes in weight determined on the weighing plates.

4. The method according to claim 2, which further comprises:
recording at least one image of the weighing area by means of at least one camera;
determining a type and position of objects for refrigeration located on the weighing area from the at least one image; and
checking for an agreement of positions determined by means of the weighing plates and by means of positions of objects for refrigeration determined from the at least one image, and with an agreement in the positions for a respective object for refrigeration the type is linked to the object weight.

5. The method according to claim 4, which further comprises storing the type determined for the at least one object for refrigeration in a database linked at least with the object weight.

6. The method according to claim 4, wherein a grid of the weighing plates overlies the at least one image in order to determine a position of the at least one object for refrigeration.

7. The method according to claim 4, which further comprises determining a position of a support surface of the at least one object for refrigeration with respect to the weighing plates in order to determine the position of the at least one object for refrigeration.

8. The method according to claim 4, wherein a liquid volume is determined from the object weight of the at least one object for refrigeration and its recognized type.

9. A refrigeration apparatus, comprising:
a household refrigeration appliance containing a refrigerating zone having a weighing area with a plurality of weighing plates, wherein the refrigeration apparatus being configured to perform a method for determining an object weight of at least one object for refrigeration positioned on said weighing area, the refrigeration apparatus configured to:
measure respective weights in a time-resolved manner by means of said weighing plates and a sum of changes in weight determined on said weighing plates within a predetermined period of time is assigned to the at least one object for refrigeration as the object weight.

10. The refrigeration apparatus according to claim 9, wherein said household refrigeration appliance has a door with a door rack, said weighing area is disposed in said door rack.

11. The refrigeration apparatus according to claim 9, wherein said door rack is formed from a transparent material.

12. The refrigeration apparatus according to claim 9, wherein said household refrigeration appliance has a data processing apparatus for carrying out the method.

13. The refrigeration apparatus according to claim 9, wherein said household refrigeration appliance has a communication apparatus for exchanging data with at least one external instance and is configured to send measured weights and at least one image to the external instance, and the external instance is configured to determine the object weight of the at least one object for refrigeration therefrom.
